(19) United States
(12) Patent Application Publication
(10) Pub. No.: US 2026/0093137 A1
(43) Pub. Date: Apr. 2, 2026

(54) DISPLAY DEVICE

(71) Applicant: Japan Display Inc., Tokyo (JP)

(72) Inventors: Yu-Sheng CHEN, Kaohsiung City (TW); Ming-Hsiang LEE, Kaohsiung City (TW); Chih-Yueh TSAI, Kaohsiung City (TW); Shih-Che LIN, Kaohsiung City (TW); Chung-Ting CHANG, Kaohsiung City (TW); Chung-Hsien HO, Kaohsiung City (TW)

(21) Appl. No.: 19/340,154

(22) Filed: Sep. 25, 2025

(30) Foreign Application Priority Data
Sep. 27, 2024 (TW) 113137136

(51) Int. Cl. G02F 1/1333; H01Q 1/22

(52) U.S. Cl. CPC G02F 1/133308; H01Q 1/22

(57) ABSTRACT

According to one embodiment, a display device includes a display module, and a frame body arranged on a back side of the display module. The frame body defines an accommodating space together with the back side of the display module and is formed with an opening which is communicated with the outside and the accommodating space.

### CROSS-REFERENCE TO RELATED APPLICATIONS

This application is based upon and claims the benefit of priority from Taiwanese Patent Application No. 113137136, filed Sep. 27, 2024, the entire contents of which are incorporated herein by reference.

### FIELD

Embodiments described herein relate generally to a display device, and more particularly, to a display device which may be equipped with a component (e.g., a sensing antenna with a signal transmission and reception function) with a specific function.

### BACKGROUND

JP 2007-257483 A discloses a conventional display device, which has a read/write function for a contactless IC card in addition to a display function, and includes a frame body, a liquid crystal display unit accommodated in the frame body, and a read/write unit composed of an antenna and other components, wherein the read/write unit is arranged on a back side of the liquid crystal display unit opposite to its display area.

However, the frame body of the conventional display device does not have a structure from which the read/write unit can be installed or removed from the outside. Therefore, when the read/write unit needs to be installed or removed, the frame body and the liquid crystal display unit must be separated before relevant operations can be performed, which is extremely inconvenient for an operator. In addition, frequent disassembly of the frame body easily leads to deformation or damage of the frame body, which not only affects the appearance of the display device, but also reduces a protective effect of the frame body on the read/write unit and the liquid crystal display unit. In this way, the reliability and durability of the conventional display device can be reduced.

### BRIEF DESCRIPTION OF THE DRAWINGS

FIG. 1 is a three-dimensional schematic diagram illustrating a first embodiment of a display device of the present invention.

FIG. 2 is a schematic side view of the first embodiment.

FIG. 3 is a schematic sectional view along a line III-III in FIG. 1.

FIG. 4 is a schematic sectional view similar to FIG. 3, illustrating a modified example of the first embodiment.

FIG. 5 is a schematic sectional flowchart, illustrating a process of installing a sensing antenna in a frame body in the first embodiment.

FIG. 6 is a schematic sectional flowchart, illustrating a process of installing the sensing antenna to which a ferrite sheet is attached in the frame body in this modified example of the first embodiment.

FIG. 7 is a schematic sectional flowchart, illustrating another state of a fixing unit in the first embodiment.

FIG. 8 is a schematic top view, illustrating a relationship of a protruding portion of the frame body, a sensing portion of the sensing antenna, and a projection area of a ferrite sheet in the first embodiment.

FIG. 9 is a schematic top view, illustrating another modified example of the first embodiment.

FIG. 10 is a schematic top view, illustrating yet another modified example of the first embodiment.

FIG. 11 is a schematic top view, illustrating still another modified example of the first embodiment.

FIG. 12 is a schematic flowchart, illustrating a second embodiment of the display device of the present invention.

FIG. 13 is a schematic sectional view along a line XIII-XIII in FIG. 12.

FIG. 14 is a schematic flowchart, illustrating a modified example of the second embodiment.

FIG. 15 is a schematic sectional view along a line XV-XV in FIG. 14.

### DETAILED DESCRIPTION

An object of the embodiments is to provide a display device that can overcome at least one disadvantage of the prior art.

In general, according to an embodiment, a display device includes a display module, and a frame body arranged on a back side of the display module. The frame body and the back side of the display module define an accommodating space together, and the frame body is formed with an opening which is communicated with the outside and the accommodating space.

By virtue of the structure of the frame body having the opening, a component (e.g., a sensing antenna) to be installed, which has a specific function, can be directly installed in the accommodating space of the frame body through the opening from the outside of the frame body without separating the frame body from the display module, or the above-mentioned component can be removed from the accommodating space through the opening. In this way, the display device of the present invention can not only ensure its reliability and durability, but also greatly improve the convenience of replacing different functional components, thereby meeting consumer's needs for customization.

According to another embodiment, a display device includes a display module, a frame body, a sensing antenna, and a ferrite sheet. The frame body is arranged on a back side of the display module, defines an accommodating space together with the back side of the display module, and is formed with an opening which is communicated with the outside and the accommodating space. The sensing antenna includes a first portion and a second portion which are connected, wherein the first portion is located in the accommodating space, and the second portion extends from the first portion through the opening of the frame body to the outside of the frame body. The ferrite sheet is located in the accommodating space and arranged between the sensing antenna and the frame body.

By virtue of the structure of the frame body having the opening, the sensing antenna can be directly installed in the accommodating space of the frame body through the opening from the outside of the frame body without separating the frame body from the display module, or the sensing antenna can be removed from the accommodating space through the opening. In this way, the display device of the present invention can ensure its reliability and durability.

Before the embodiments are described in detail, it should be noted that the drawings mentioned in the following description only illustrate the basic idea of the present invention in a schematic manner, so that only the components related to the present embodiments are displayed in the drawings and are not drawn according to the number, shapes and sizes of the components at the time of actual implementation. The types, number and proportions of various components can be changed during actual implementation, and the layout type may also be more complex.

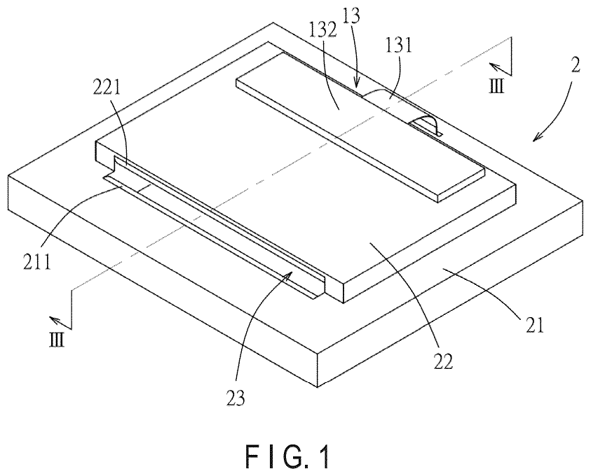

Referring to FIG. 1 to FIG. 3, a first embodiment of a display device of the present invention includes a display module 1 and a frame body 2, wherein the display module 1 has a front surface and a back surface which are opposite to each other, the front surface is used for a displaying purpose, and the frame body 2 is arranged on the back side of the display module 1.

In the first embodiment, the display module 1 is a liquid crystal display (LCD), and includes an LCD panel 11, a backlight unit 12 disposed on a back side of the LCD panel 11, a scratch-resistant sheet 14 arranged on a back side of the backlight unit 12, and a control unit 13, but the present invention is not limited thereto. In other embodiments, the display module 1 may also be an organic light emitting diode (OLED) display or a light emitting diode (LED) display, etc.

The LCD panel 11 may be a twisted nematic (TN) LCD panel, a multi-domain vertical alignment (MVA) LCD panel, an in-plane switching (IPS) LCD panel, or a fringe field switching (FFS) LCD panel, or other different types of LCD panels.

The backlight unit 12 includes a light source, a light guide mechanism, and a reflective sheet. The light source is arranged on one side of the light guide mechanism. The light guide mechanism may include an optical film, and a light guide plate configured to guide light emitted by the light source toward the LCD panel 11 and to make the light emitted by the light source uniform to form a surface light source. The reflective sheet is arranged on a back side of the light guide plate opposite to the LCD panel 11 to reflect light emitted from the back side of the light guide plate toward the LCD panel 11, thereby improving the luminous efficiency of the backlight unit 12. The scratch-resistant sheet 14 covers the reflective sheet of the backlight unit 12. Here, the scratch-resistant sheet 14 may cover the entire reflective sheet, or may only cover a portion of the reflective sheet. It should be noted that when the display module 1 is an OLED display or an LED display having self-luminescence, the display module 1 is not provided with the backlight unit 12.

The control unit 13 is electrically connected to a trace in the LCD panel 11, may drive and control the display of the LCD panel 11, and includes a flexible substrate 131 electrically connected to a scan line and a data line of the LCD panel 11, and a control circuit board 132 electrically connected to a trace in the flexible substrate 131. In the first embodiment, the flexible substrate 131 is a flexible printed circuit (FPC), and the control circuit board 132 is a printed circuit board (PCB), but the present invention is not limited thereto.

It should be noted that the LCD panel 11, the backlight unit 12, and the control unit 13 are prior arts and are not within the scope of the present invention. The more detailed structures and operating principles of these components will not be further described herein.

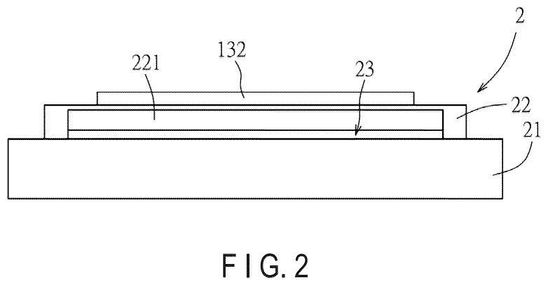

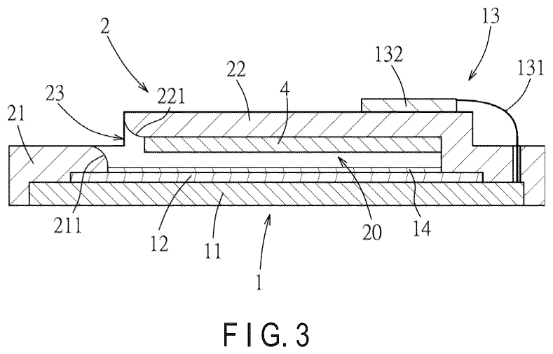

Referring to FIG. 3, the frame body 2 and the back side of the display module 1 define an accommodating space 20 together, and the frame body 2 is formed with an opening 23 which is communicated with the outside and the accommodating space 20. Also, in the first embodiment, as shown in FIG. 1 and FIG. 2, the opening 23 is formed into an elongated shape through which a sheet-like object can pass. In the first embodiment, the frame body 2 is made of a metal material (e.g., aluminum), but the present invention is not limited thereto. In other implementations, the frame body 2 may also be made of other materials (e.g., plastic).

In the first embodiment, as shown in FIG. 3, the frame body 2 includes an outer frame portion 21 surrounding the periphery of the LCD panel 11 and the periphery of the backlight unit 12, and a protruding portion 22 that protrudes relative to the outer frame portion 21 in a direction away from the display module 1. The outer frame portion 21 and the protruding portion 22 are formed into a whole. The outer frame portion 21 surrounds the protruding portion 22 (see FIG. 1), and an inner peripheral end of the outer frame portion 21 is connected to an outer peripheral end of the protruding portion 22. The accommodating space 20 is defined jointly by an inner wall of the protruding portion 22, an inner peripheral wall of the outer frame portion 21, and a back surface of the display module 1, but the present invention is not limited thereto. In other modified examples, the frame body 2 may not include the protruding portion 22 (not shown). In other words, in the present invention, the accommodating space 20 is defined between the frame body 2 and the back surface of the display module 1. However, in other embodiments, the outer frame portion 21 may also be configured to surround the periphery of the backlight unit 12 instead of surrounding the periphery of the LCD panel 11. In the first embodiment, as shown in FIG. 3, the opening 23 is formed on the outer frame portion 21 and the protruding portion 12, but the present invention is not limited thereto. In other implementations, the opening 23 may also be formed only on the protruding portion 12 or only on the outer frame portion 21.

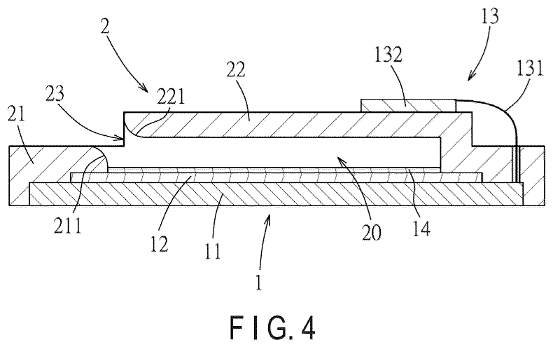

In the first embodiment, as shown in FIG. 3, the display device further includes a ferrite sheet 4 which is located in the accommodating space 20 and attached to an inner wall of the frame body 2, but the present embodiment is not limited thereto. In a modified example shown in FIG. 4, the ferrite sheet 4 is not attached to the inner wall of the frame body 2.

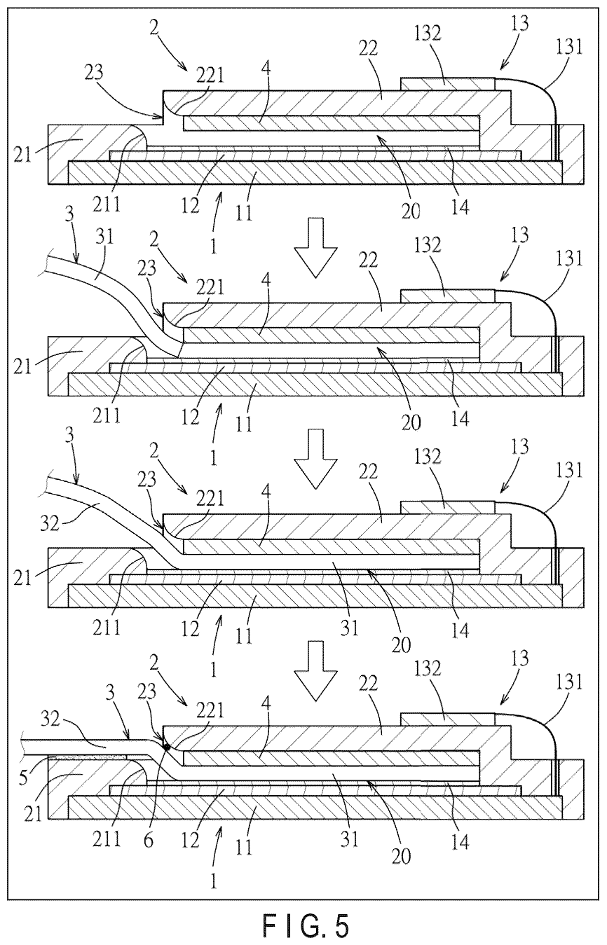

In the first embodiment, the display device further includes a sensing antenna. As shown in FIG. 5, the sensing antenna 3 may be inserted into the opening 23 from the outside of the frame body 2 at a proper angle, and then enter and be installed in the accommodating space 20. It should be noted that, in the first embodiment, a first chamfer 211 is formed on a periphery of the outer frame portion 21 that defines the opening 23, and a second chamfer 221 is formed on a periphery of the protruding portion 22 that defines the opening 23. By virtue of the structures of the first chamfer 211 and the second chamfer 221, when the sensing antenna 3 enters the accommodating space 20 through the opening 23, the sensing antenna 3 can be prevented from being scratched or scraped by the peripheries of the outer frame portion 21 and the protruding portion 22. Furthermore, there is an appropriate distance between the first chamfer 211 and the second chamfer 221, so that the sensing antenna 3 may enter the accommodating space 20 at a preferred angle, and then the sensing antenna 3 may be smoothly installed in the accommodating space 20. Also, when the elongated opening 23 is formed only in the protruding portion 12 or only in the outer frame portion 21, the opening 23 needs to have an appropriate width to ensure that the sensing antenna 3 can smoothly enter the accommodating space 20 via the opening 23. After the sensing antenna 3 has been installed, the ferrite sheet 4 is located between the sensing antenna 3 and the frame body 2. Also, when the sensing antenna 3 is installed in a state shown in FIG. 4, the ferrite sheet 4 is not disposed between the sensing antenna 3 and the frame body 2. It should be noted that, by configuring the scratch-resistant sheet 14, the backlight unit 12 (i.e., the reflective sheet) can be prevented from being damaged by scrapes, friction, or scratches when the sensing antenna 3 enters the accommodating space 20, thereby enhancing a protection function of the backlight unit 12.

In the first embodiment, the accommodating space 20 is configured to accommodate the sensing antenna 3 having a signal transmission and reception function, so that the display device of the present embodiment may be adapted to sense a signal emitted by a mobile device (e.g., a smart phone, a wearable device such as an electronic watch, a tablet computer, or an IC card).

It should be noted that in the first embodiment, a description is made by taking the sensing antenna 3 being inserted into the accommodating space 20 of the frame body 2 as an example, but the present embodiment is not limited thereto. In other implementations, components with other functions (e.g., global positioning system (GPS) components) may enter into the accommodating space 20 from the outside of the frame body 2 via the opening 23 and be installed in the accommodating space 20 according to the needs of consumers, so that the display device of the present embodiment has a required function.

The sensing antenna 3 may receive a signal emitted by the mobile device. The sensing antenna 3 may communicate with the mobile device via, for example, near-field communication (NFC), WiFi or Bluetooth. The mobile device may be, for example, a smart phone with a near field communication function, a tablet computer with a near field communication function, or an IC card using a radio frequency identification (RFID) technology, etc.

As shown in FIG. 5, the sensing antenna 3 includes a sensing portion 31, and a reading portion 32 electrically connected to the sensing portion 31. When the sensing antenna 3 is installed in the accommodating space 20 of the frame body 2, the reading portion 32 and the sensing portion 31 are respectively arranged on both opposite sides of the frame body 2 (that is, the reading portion 32 is arranged on the back side of the frame body 2 and located outside the accommodating space 20). The reading portion 32 includes a reader circuit substrate capable of reading a signal received by the sensing portion 31. In the first embodiment, as shown in FIG. 5, the reading portion 32 and the sensing portion 31 are formed on the same flexible printed circuit board and are electrically connected to each other. One portion of the flexible printed circuit board (i.e., the sensing portion 31) is located in the accommodating space 20, and the other portion of the flexible printed circuit board (i.e., the reading portion 32) extends to the outside of the frame body 2 through the opening 23 of the frame body 2. In other implementations, the reading portion 32 is formed on a printed circuit board and electrically connected to the sensing portion 31 (e.g., through wire bonding or a connector). Also, in another implementation, the sensing portion 31 is formed on a flexible printed circuit board, the reading portion 32 is formed on a printed circuit board, and the printed circuit board and the flexible printed circuit board are electrically connected via a connecting line that passes through the opening 23 of the frame body 2, the connecting line being a signal transmission line, such as a coaxial cable. In yet another implementation, the reading portion 32 may have a function of writing information into the mobile device.

It should be noted that in the first embodiment, the display module 1 and the sensing antenna 3 may both be in signal connection with a device having a signal transmission and reception or processing function (e.g., a computer). Specifically, the above device may receive and process the signal read by the reading portion 32 of the sensing antenna 3, then transmit the processed signal to the display module 1, and display relevant information through the display module 1, but the present embodiment is not limited thereto.

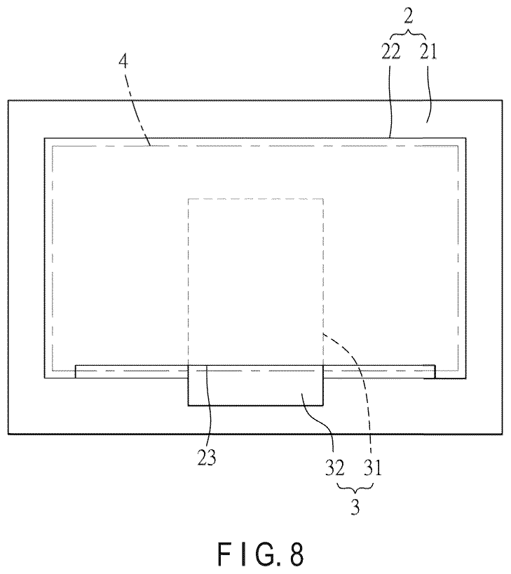

It should be noted that a projection shape or projection area of the protruding portion 22 in a top-view direction (a vertical direction facing a front surface of the display module 1, i.e., a direction from bottom to top in FIG. 3) on a reference plane perpendicular to the top-view direction can be changed as needed. For example, when the sensing antenna 3 is installed in the accommodating space 20, the projection area of the protruding portion 22 may be equal to, greater than, or even much greater than the projection area of the sensing portion 31 of the sensing antenna 3 (see FIG. 5). When a proportion of the projection area relative to the frame body 2 is increased, a larger accommodating space 20 can be provided, thereby providing the freedom of arranging the sensing antenna 3 and providing enough space to accommodate a plurality of sensing antennas 3. In the first embodiment, the length and width of the sensing portion 31 of the sensing antenna 3 are 60 mm and 40 mm, respectively, while the projection area of the protruding portion 22 is much greater than the projection area of the sensing portion 31 (see FIG. 8), but the present embodiment is not limited thereto.

In the first embodiment, as shown in FIG. 5, the display device further includes a fixing unit 5 configured to fix the sensing antenna 3, and a sealing member 6 configured to seal the accommodating space 20. The fixing unit 5 includes a double-sided adhesive tape for adhering the sensing antenna 3 to the frame body 2 (see FIG. 5). Specifically, the double-sided adhesive tape is configured to attach the reading portion 32 of the sensing antenna 3 to the outside of the frame body 2 to fix the sensing antenna 3. After the sensing antenna 3 has been fixed, the sealing member 6 is configured to seal the accommodating space 20, thereby preventing external dust or particles from entering the accommodating space 20 through the opening 23 and contaminating the sensing portion 31. In other embodiments, the fixing unit 5 may also include, for example, a locking member for locking the sensing antenna 3 to the frame body 2.

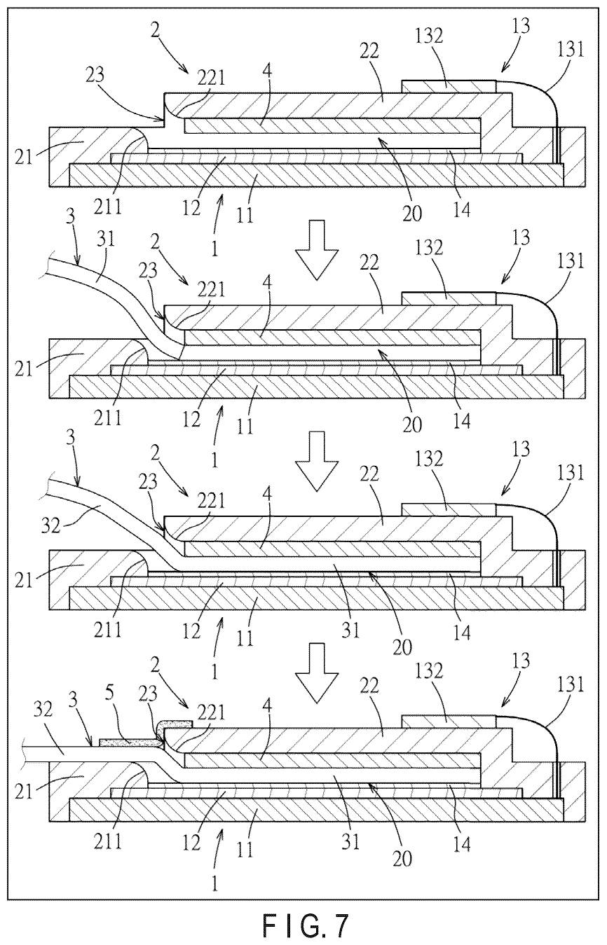

In another implementation, as shown in FIG. 7, the fixing unit 5 includes an adhesive sheet for fixing the sensing antenna 3 to the frame body 2. Specifically, the adhesive sheet is attached across an outer side surface of the protruding portion 22, the reading portion 32 of the sensing antenna 3, and an outer side surface of the outer frame portion 21, such that the reading portion 32 of the sensing antenna 3 can be fixed to the outside of the frame body 2, and the opening 23 can be sealed to prevent external dust or particles from entering the accommodating space 20 through the opening 23.

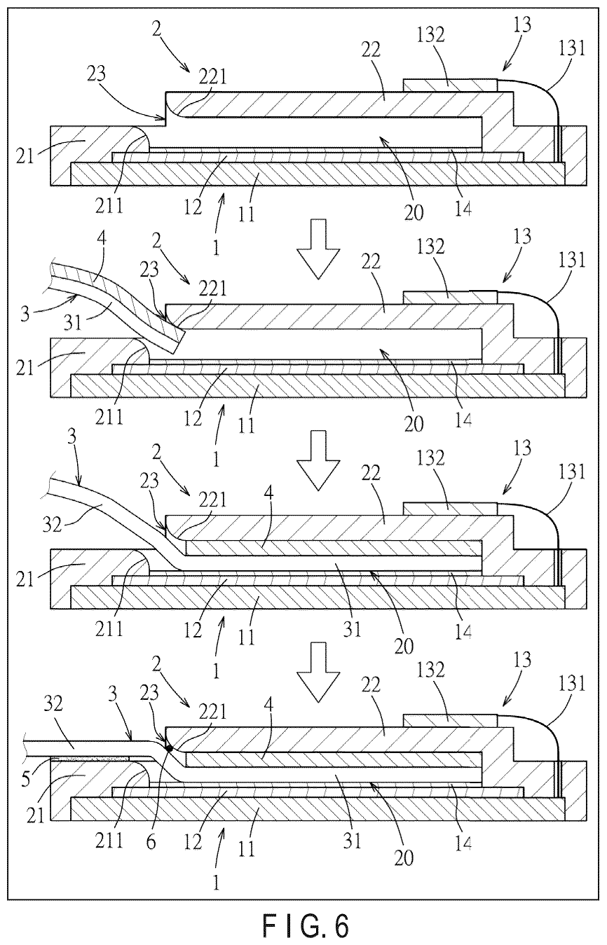

In a modified example shown in FIG. 6, the display device further includes a sensing antenna 3 to which the ferrite sheet 4 is attached, that is, the ferrite sheet 4 is attached to the sensing antenna 3 in advance. The sensing antenna 3 may enter the accommodating space 20 from the outside of the frame body 2 via the opening 23 at a proper angle, and is installed in the accommodating space 20 with the ferrite sheet 4 facing the inner wall of the frame body 2. In this way, after the sensing antenna 3 has been installed, the ferrite sheet 4 is located between the sensing antenna 3 and the frame body 2.

In the first embodiment, as shown in FIG. 8, the projection area of the ferrite sheet 4 is equal to or greater than the projection area of the sensing portion 31 of the sensing antenna 3, so that the signal interference of the frame body 2 made of metal or other external components on the sensing portion 31 can be suppressed more effectively. Therefore, by ensuring that the projection area of the ferrite sheet 4 is equal to or greater than the projection area of the sensing portion 31, the communication quality of the sensing antenna 3 can be effectively improved, but the present embodiment is not limited thereto.

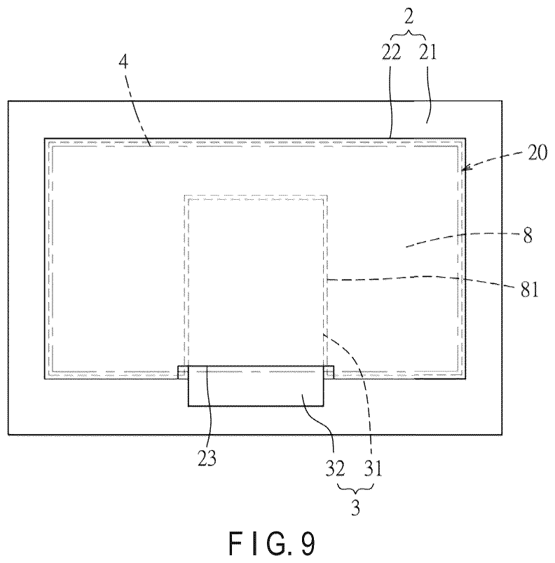

In a modified example shown in FIG. 9, the display device further includes a supporting member 8 disposed in the accommodating space 20, and the length of the elongated opening 23 is designed to allow the sensing antenna 3 to pass through. In the first embodiment, the supporting member 8 is made of an insulating material, but the present embodiment is not limited thereto. Specifically, the supporting member 8 is arranged in the accommodating space 20 in advance. The supporting member 8 is formed with a hollow portion 81 capable of accommodating the sensing portion 31 of the sensing antenna 3. The hollow portion 81 is formed at a side edge of the supporting member 8 and communicated with the opening 23. The sensing antenna 3 may enter the hollow portion 81 of the supporting member 8 through the opening 23 and be appropriately accommodated in the hollow portion 81. After the sensing antenna 3 has been installed, the supporting member 8 substantially fills a portion of the accommodating space 20 that is not occupied by the sensing antenna 3 and the ferrite sheet 4. The configuration of the supporting member 8 can effectively support the sensing portion 31 located in the accommodating space 20, such that the shift of the sensing portion 31 in the frame body 2 (even leading to the offset of a sensing position) can be avoided, and debris or particles generated by rubbing of the sensing portion 31 against the frame body 2 can also be avoided.

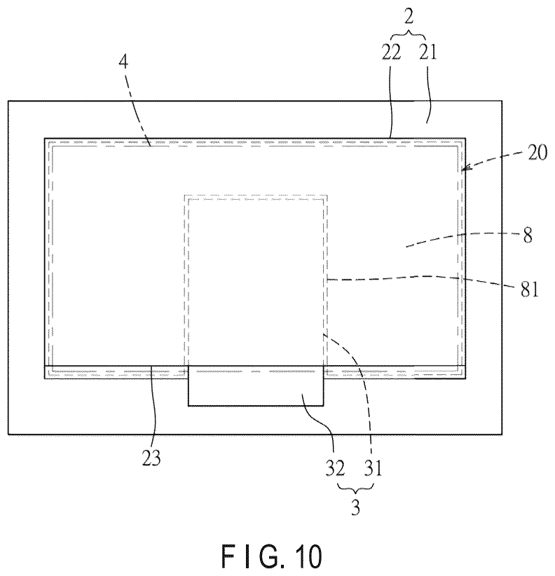

A modified example shown in FIG. 10 differs from a modified example shown in FIG. 9 in that the length of the opening 23 is designed to allow the supporting member 8 to pass through. The sensing antenna 3 may be arranged in the hollow portion 81 of the supporting member 8 in advance and enter the accommodating space 20 through the opening 23 together with the supporting member 8 to complete the installation, but the present embodiment is not limited thereto. In another implementation, the supporting member 8 may be arranged in the accommodating space 20 through the opening 23, and then the sensing antenna 3 may enter the accommodating space 20 through the opening 23 and be installed in the hollow portion 81.

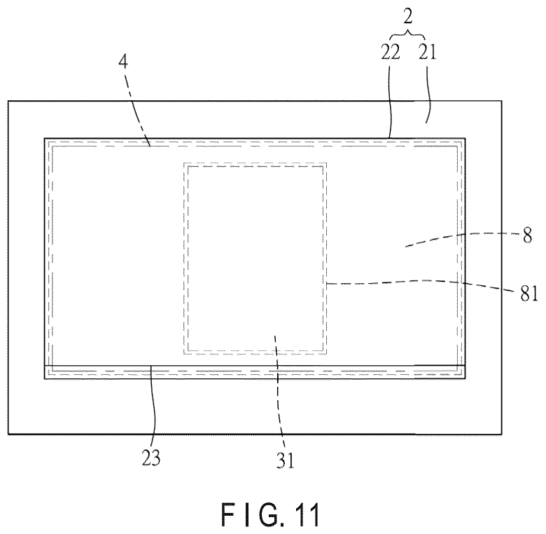

A modified example shown in FIG. 11 differs from a modified example shown in FIG. 10 in that the hollow portion 81 is formed at a central position of the supporting member 8. The sensing portion 31 of the sensing antenna 3 is arranged in the hollow portion 81 of the supporting member 8 in advance, and enters the accommodating space 20 through the opening 23 together with the supporting member 8 to complete the installation. After the sensing antenna 3 and the supporting member 8 have been installed, the sensing antenna 3 and the supporting member 8 substantially fill the accommodating space 20, so that the sensing portion 31 can be fixed in the accommodating space 20. This modified example can not only fix the sensing portion 31, but also prevent external dust or particles from contaminating the sensing portion 31. In order to simplify the diagrams, the reading portion 32 of the sensing antenna 3 is omitted and not shown in FIG. 11. In actual implementation, the reading portion 32 may be arranged together with the sensing portion 31 in the hollow portion 81 of the supporting member 8, or may be arranged outside the frame body 2 and electrically connected to the sensing portion 31 located in the accommodating space 20 through a connecting line.

It should be noted that in FIGS. 9 to 11, the hollow portion 81 of the supporting member 8 is drawn to have a gap with the sensing portion 31 of the sensing antenna 3. This is only for the convenience of illustrating a positional relationship between the sensing portion 31 and the hollow portion 81, and does not represent a dimension scale of the sensing portion 31 and the hollow portion 81.

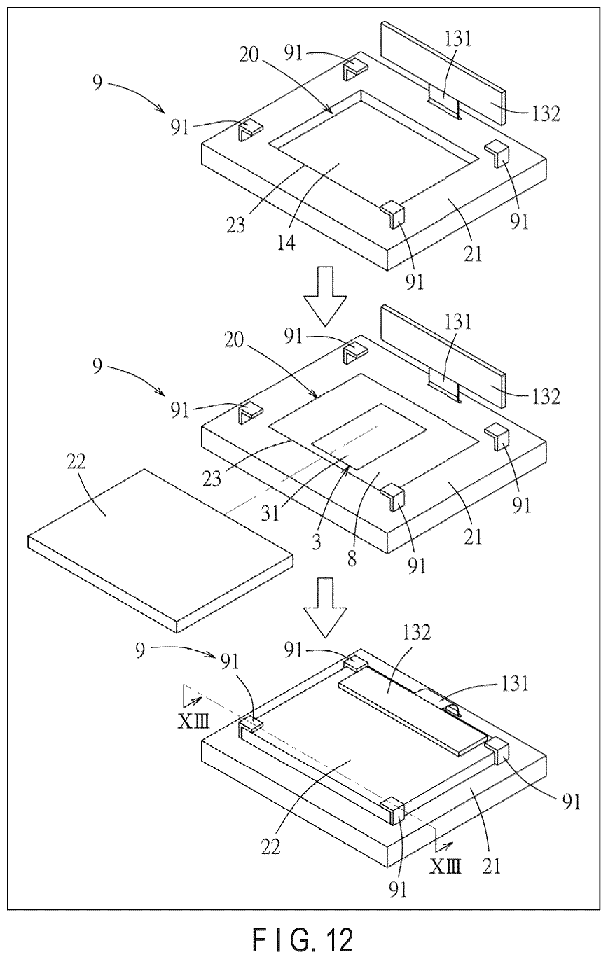

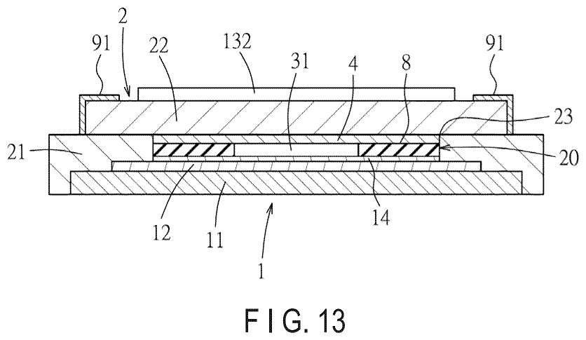

Referring to FIG. 12 and FIG. 13, the second embodiment of the display device of the present embodiment is similar to the first embodiment, except that the opening 23 is formed in the outer frame portion 21 of the frame body 2 and is formed to have an appropriate length and width. The accommodating space 20 is defined jointly by an inner peripheral wall of the outer frame portion 21 and the back surface of the display module 1. The protruding portion 22 and the outer frame portion 21 are separable components. The protruding portion 22 removably covers the opening 23. The display device further includes a positioning unit 9 for positioning the protruding portion 22. In the second embodiment, the positioning unit 9 includes four approximately L-shaped engaging members 91 which are arranged on an outer side wall (the outer side is a side away from the display module 1) of the outer frame portion 21. Each engaging member 91 includes a connecting end connected to the outer frame portion 21 and a free end opposite to the connecting end. The engaging members 91 are opposite to each other in pairs, and the free ends of each pair of engaging members 91 face each other (see FIG. 12). The engaging members 91 and the outer wall of the outer frame portion 21 jointly define an engaging space. However, in the present embodiment, the structure and configuration of the positioning unit 9 are not limited to the above.

As shown in FIG. 12, the sensing portion 31 of the sensing antenna 3 and the supporting member 8 may enter the accommodating space 20 in a flat manner through the opening 23 in a direction from top to bottom in FIG. 12. Then, the protruding portion 22 may slide into the engaging space along a horizontal direction in FIG. 12 (i.e., a horizontal direction perpendicular to an imaginary line connecting the free ends of each pair of engaging members that face each other), thereby covering the opening 23 to fix the sensing portion 31 and the supporting member 8 in the accommodating space 20. Here, as shown in FIG. 13, the protruding portion 22 is fixed to the outer frame portion 21 by engaging with the engaging members 91. That is, the protruding portion 22 is engaged and fixed jointly by the engaging members 91 and the outer wall of the outer frame portion 21. It should be noted that, in the present embodiment, the ferrite sheet 4 (see FIG. 13) may be placed on the sensing portion 31 after the sensing portion 31 is arranged, and then the protruding portion 22 is installed; or the ferrite sheet 4 is installed on the inner wall of the protruding portion 22 in advance, and installed and positioned together with the protruding portion 22 in a slide-in manner.

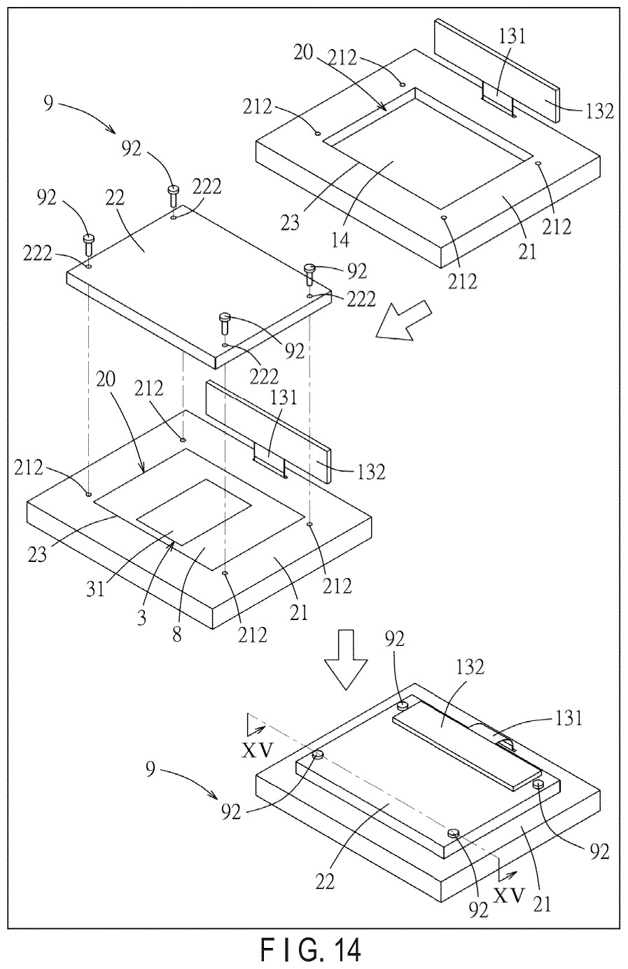

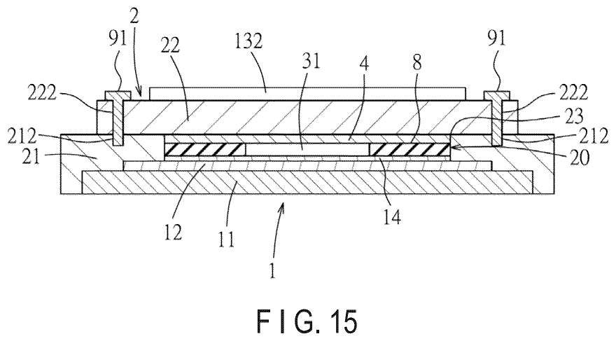

In a modified example of the second embodiment as shown in FIG. 14 and FIG. 15, the positioning unit 9 includes four locking members 92, for example, but not limited to four screws formed with external threads (not shown); the outer frame portion 21 is provided with four locking holes 212, for example, but not limited to four screw holes formed with internal threads (not shown) that may be mutually screwed with the external threads of the screws; and the protruding portion 22 is provided with four through holes 222, the positions of which respectively correspond to the screw holes of the outer frame portion 21. Here, after the sensing portion 31 and the supporting member 8 are disposed in the accommodating space 20, the protruding portion 22 may cover the opening 23 along a direction from top to bottom in FIG. 14, and the through holes 222 of the protruding portion 22 are mutually aligned with the screw holes of the outer frame portion 21. Next, the screws are screwed into the screw holes through the through holes 222. In this way, the protruding portion 22 is fixed to the outer frame portion 21, thereby achieving an effect of fixing the sensing portion 31 and the supporting member 8 in the accommodating space 20 at the same time. It should be noted that, here, the locking members 92 are described using screws as an example, but the present embodiment is not limited thereto. In other implementations, the locking members 92 may also be, for example, pins or rivets. A person of ordinary skill in the art should understand that the form of the locking holes 212 needs to be adjusted accordingly.

It should be noted that in the second embodiment, the protruding portion 22 completely covers the opening 23 after installation, but the present embodiment is not limited thereto. In other implementations, the protruding portion 22 may leave a gap (not shown) at the opening 23 after installation, while the reading portion 32 of the sensing antenna 3 may extend out of the frame body 2 via the gap. The sensing antenna 3 may also be installed in the accommodating space 20 via the gap in an insertion manner. In this way, the degree of freedom in the installation method of the sensing antenna 3 and the supporting member 8 can be improved.

In addition, to simplify the drawings, the reading portion 32 of the sensing antenna 3 is not shown in FIGS. 12 to 15. In fact, the reading portion 32 may be arranged on an outer side surface of the outer frame portion 21 or the protruding portion 22 and electrically connected to the sensing portion 31 located in the accommodating space 20 through a connecting line (not shown), or may be arranged together with the sensing portion 31 in the hollow portion 81 of the supporting member 8. When the reading portion 32 is arranged on the outer side surface of the outer frame portion 21 or the protruding portion 22, the connecting line may be electrically connected to the sensing portion 31 through a through hole (not shown) formed in the protruding portion 22 or the above-mentioned gap.

It is worth noting that when the LCD panel 11 of the display module 1 is an IPS LCD panel or an FFS LCD panel, a pixel electrode and a common electrode, which are made of a transparent conductive material such as indium tin oxide (ITO), are both located on a thin film transistor array substrate, and there is a slit between the electrodes. Therefore, signals transmitted between the sensing antenna 3 and the mobile device may be partially transmitted to the sensing antenna 3 or the mobile device through the display module 1 via the slit.

It can thus be seen that when the LCD panel 11 is an IPS LCD panel or an FFS LCD panel, the display device of the present embodiment may have a better viewing angle and better color restoration degree, and may also have better communication quality. Also, when the impedance of the common electrode of the LCD panel 11 is in a range of 50Ω to 200Ω, the shielding of the common electrode on the transmitted signals can be reduced, thereby further improving the signal transmission efficiency of the display device of the present embodiment.

Through the above description, the advantages of the display device of the present embodiment can be summarized as follows.
1. By virtue of the structure of the frame body 2 having the opening 23, a component (e.g., a sensing antenna) to be installed, which has a specific function, can be directly installed in the accommodating space 20 of the frame body 2 through the opening 23 from the outside of the frame body 2 without separating the frame body 2 from the display module 1, or the above-mentioned component can be removed from the accommodating space 20 through the opening 23. In this way, the display device of the present embodiment can not only ensure its reliability and durability, but also greatly improve the convenience of replacing different functional components, thereby meeting consumer's needs for customization.
2. By fixing the sensing antenna 3 with the fixing unit 5, the shift of the sensing antenna 3 in the frame body 2 (even leading to the offset of the sensing position) can be avoided. In this way, it can be ensured that the display device of the present embodiment has good sensing or communication quality.
3. Due to the design of the frame body 2 having the chamfers 211 and 221 and the configuration of the display module 1 having the scratch-resistant sheet 14, the sensing antenna 3 or the backlight unit 12 can be prevented from being scraped, rubbed, or scratched when the sensing antenna 3 is installed.
4. Since the ferrite sheet 4 is configured such that the projection area of the ferrite sheet 4 on the reference plane in a top-view direction is equal to or greater than the projection area of the sensing portion 31 of the sensing antenna 3, the signal interference of the frame body 2 made of metal or other external components on the sensing portion 31 can be suppressed more effectively.
5. By sealing the accommodating space 20 with the sealing member 6 or the fixing unit 5, external dust or particles can be prevented from entering the accommodating space 20.
6. By maximizing the accommodating space 20, the degree of freedom in the arrangement of the sensing antenna 3 can be ensured.
7. Since the supporting member 8 supports the sensing portion 31 of the sensing antenna 3, the shift of the sensing portion 31 in the frame body 2 can be avoided, and debris or particles generated by rubbing of the sensing portion 31 against the frame body 2 can also be avoided. In this way, it can be ensured that the display device of the present embodiment has good durability.

However, the above is only the embodiments of the present invention, but cannot be intended to limit the scope of the present invention. All simple equivalent changes and modifications made in accordance with the scope of the patent application for the present invention and the contents of the patent specification are still within the scope of the present invention patent.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A display device comprising a display module, and a frame body arranged on a back side of the display module, the frame body defining an accommodating space together with the back side of the display module, and the frame body being formed with an opening which is communicated with the outside and the accommodating space.

2. The display device according to claim 1, further comprising a sensing antenna installed in the accommodating space, and the opening is configured to allow the sensing antenna to enter the accommodating space from the outside of the frame body.

3. The display device according to claim 1, further comprising a ferrite sheet located in the accommodating space and attached to an inner wall of the frame body.

4. The display device according to claim 3, further comprising a sensing antenna installed in the accommodating space, wherein the opening is configured to allow the sensing antenna to enter the accommodating space from the outside of the frame body.

5. The display device according to claim 1, further comprising a sensing antenna to which a ferrite sheet is attached, wherein the opening allows the sensing antenna to enter the accommodating space from the outside of the frame body, and the sensing antenna is installed in the accommodating space with the ferrite sheet facing an inner wall of the frame body.

6. The display device according to claim 2, further comprising a fixing unit configured to fix the sensing antenna to the frame body.

7. The display device according to claim 6, wherein the fixing unit comprises an adhesive sheet configured to adhere the sensing antenna to the frame body.

8. The display device according to claim 2, further comprising a supporting member located in the accommodating space and configured to support the sensing antenna.

9. The display device according to claim 1, wherein the frame body comprises an outer frame portion, and a protruding portion which protrudes relative to the outer frame portion in a direction away from the display module; the accommodating space is defined jointly by the protruding portion, the outer frame portion and a back side of the display module; and the opening is defined jointly by the outer frame portion and the protruding portion.

10. The display device according to claim 1, wherein the frame body comprises an outer frame portion, and a protruding portion which protrudes relative to the outer frame portion in a direction away from the display module and can be separated from the outer frame portion; the accommodating space is defined jointly by the outer frame portion and the back side of the display module; the opening is formed in the outer frame portion; and the protruding portion removably covers the opening.

11. The display device according to claim 10, further comprising a positioning unit configured to position the protruding portion on the outer frame portion.

12. The display device according to claim 11, wherein the positioning unit comprises at least one engaging member arranged on an outer side wall of the outer frame portion, and the protruding portion can be engaged and fixed jointly by the at least one engaging member and the outer wall of the outer frame portion.

13. The display device according to claim 11, wherein the positioning unit comprises at least one locking member; the outer frame portion comprises at least one locking hole; the protruding portion comprises at least one through hole corresponding to the at least one locking hole; and the protruding portion is positioned on the outer frame portion by locking the at least one locking member with the at least one locking hole via the at least one through hole.

14. The display device according to claim 1, wherein the display module comprises an LCD panel, and a backlight unit arranged on a back side of the LCD panel.

15. A display device comprising:
a display module;
a frame body arranged on a back side of the display module, defining an accommodating space together with the back side of the display module, and formed with an opening communicated with the outside and the accommodating space;
a sensing antenna comprising a first portion and a second portion which are connected, the first part being located in the accommodating space, and the second portion extending from the first portion through the opening of the frame body to the outside of the frame body; and
a ferrite sheet located in the accommodating space and arranged between the sensing antenna and the frame body.
